(19) United States
(12) Patent Application Publication
(10) Pub. No.: US 2009/0178529 A1
(43) Pub. Date: Jul. 16, 2009

(54) APPARATUS FOR CUTTING SHEET MATERIAL

(75) Inventor: Vincent T. Kozryski, Plainville, CT (US)

Correspondence Address: O''Shea Getz P.C., 1500 MAIN ST. SUITE 912, SPRINGFIELD, MA, 01115, US

(73) Assignee: The Fletcher-Terry Company, Farmington, CT (US)

(21) Appl. No.: 12/354,337

(22) Filed: Jan. 15, 2009

Related U.S. Application Data
(60) Provisional application No. 61/021,134, filed on Jan. 15, 2008.
(60) Provisional application No. 61/100,497, filed on Sep. 26, 2008.

(51) Int. Cl. B26D 1/18; B26D 7/02

(52) U.S. Cl. 83/488; 83/455

(57) ABSTRACT

According to the present invention, an apparatus for cutting a workpiece sheet is provided that includes a frame member, a clamp assembly, a cutter head assembly, and a cartridge removably mounted in the cutter head assembly. The clamp assembly has a bar that is selectively operable between a retracted position and a deployed position. The clamp assembly is operable to fix the position of the workpiece sheet relative to the frame member. The cutter head assembly is mounted on a track, which is attached to the frame member. The cutter head assembly can be selectively moved along the track. The cartridge includes a first cutting blade and a second cutting blade, both statically mounted on the cartridge. Each blade is positioned to engage the workpiece sheet as the cartridge is moved along the frame member.

Applicant hereby claims priority benefits under 35 U.S.C. §119(e) of U.S. Provisional Patent Application No. 61/021,134 filed Jan. 15, 2008, and U.S. Provisional Application No. 61/100,497 filed Sep. 26, 2008, the disclosures of which are herein incorporated by reference.

### BACKGROUND OF THE INVENTION

1. Technical Field

This invention relates to devices for cutting semi-rigid sheet materials in general, and to such devices that include clamping devices and the ability to cut a variety of different material types in particular.

2. Background Information

There are numerous devices known to the public relating to sheet material cutters that utilize a cutter head operable to move linearly across a workpiece in sheet form. The existing devices suffer from various shortcomings including, limited or no ability to clamp a workpiece, substantial limitations regarding the types of sheet materials that can be cut, or a lack of fine positional adjustability. In short, the sheet material cutting devices currently known to the public possess shortcomings that affect the performance of the devices.

What is needed is a device that can cut a variety of different types of workpiece materials, one that effectively clamps the workpiece, and one that possesses desirable adjustability.

### DISCLOSURE OF THE INVENTION

According to the present invention, an apparatus for cutting a workpiece sheet is provided that includes a frame member, a clamp assembly, a cutter head assembly, and a cartridge removably mounted in the cutter head assembly. The clamp assembly has a bar that is selectively operable between a retracted position and a deployed position. The clamp assembly is operable to fix the position of the workpiece sheet relative to the frame member. The cutter head assembly is mounted on a track, which is attached to the frame member. The cutter head assembly can be selectively moved along the track. The cartridge includes a first cutting blade and a second cutting blade, both statically mounted on the cartridge. Each blade is positioned to engage the workpiece sheet as the cartridge is moved along the frame member.

These and other objects, features, and advantages of the present invention method and apparatus will become apparent in light of the detailed description of the invention provided below and the accompanying drawings.

### BRIEF DESCRIPTION OF THE DRAWINGS

FIG. 1 is a planar view of the present device for cutting sheet material.

FIG. 2 is a side view of the present device for cutting sheet material.

FIG. 3A is a sectional view of the vertical frame assembly along section line 3-3, showing the clamp bar in a retracted position.

FIG. 3B is a sectional view of the vertical frame assembly along section line 3-3, showing the clamp bar in a deployed position.

FIG. 4A is a diagrammatic side view of the vertical frame assembly, illustrating the clamp assembly with the clamp bar in a retracted position.

FIG. 4B is a diagrammatic side view of the vertical frame assembly, illustrating the clamp assembly with the clamp bar in a deployed position.

FIG. 5A is a planar top view of the biasing assembly.

FIG. 5B is a planar side view of the biasing assembly.

FIG. 6 is a sectional view of the horizontal frame assembly cut along section line 6-6.

FIG. 7 is a sectional view of the horizontal frame assembly cut along section line 7-7.

FIG. 8 is a partial planar view of the horizontal frame assembly, including the squaring mechanism.

FIG. 9A is a planar view of the cutter head assembly with a glass scoring cartridge embodiment inserted, with the cartridge and arm in the lifted/retracted position.

FIG. 9B is a planar view of the cutter head assembly with a glass scoring cartridge embodiment inserted, with the cartridge and arm in the deployed position.

FIG. 10A is a top view of the cutter head assembly with a rotary cutter wheel cartridge inserted.

FIG. 10B is a side view of the cutter head assembly with a rotary cutter wheel cartridge inserted.

FIG. 10C is an end view of the cutter head assembly with a rotary cutter wheel cartridge inserted.

FIG. 11 is a planar view of a cartridge embodiment with a static cutting blade.

FIG. 12 is a planar view of a cartridge embodiment with a glass scoring wheel.

FIG. 13 is a planar view of a cartridge embodiment with a pair of rotary cutting wheels.

FIG. 14 is an end view of the cartridge shown in FIG. 13.

FIG. 15 is a diagrammatic sectional view of a rotary cutter wheel embodiment.

FIG. 16 is a diagrammatic sectional view of a rotary cutter wheel embodiment.

FIG. 17 is a diagrammatic sectional view of a rotary cutter wheel embodiment, illustrating deflection of the cutter wheels with force F applied.

FIG. 18 is a planar view of an embodiment of the present device for cutting sheet material, including a drive unit.

FIG. 19 is a sectional view of the vertical frame assembly along section line 3-3, including a drive unit.

FIG. 20 is a diagrammatic side view of the vertical frame assembly, illustrating a drive unit.

FIGS. 21-24 illustrate different rotary cutter wheel embodiments.

FIG. 25 is a side view of the present device for cutting sheet material, including a drive unit embodiment.

FIG. 26 is a top view of the cutter head assembly with a powered cutting tool.

FIG. 27 is an end view of the cutter head assembly with a powered cutting tool.

FIG. 28 is a planar view of a cartridge embodiment having a pair of cutting blades and a safety guard. The guard is shown in the deployed position.

FIG. 29 is a top view of the cartridge embodiment shown in FIG. 28.

FIG. 30 is a side view of the cartridge embodiment shown in FIG. 28.

FIG. 31 is a planar view of a cartridge embodiment having a pair of cutting blades and a safety guard, with the guard shown in phantom in a blade exposed position.

### DETAILED DESCRIPTION OF THE INVENTION

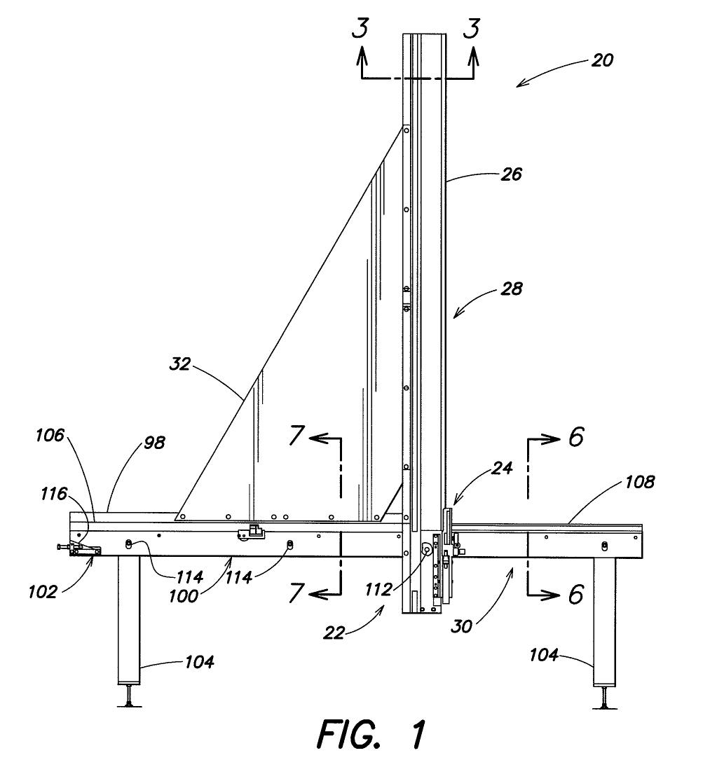

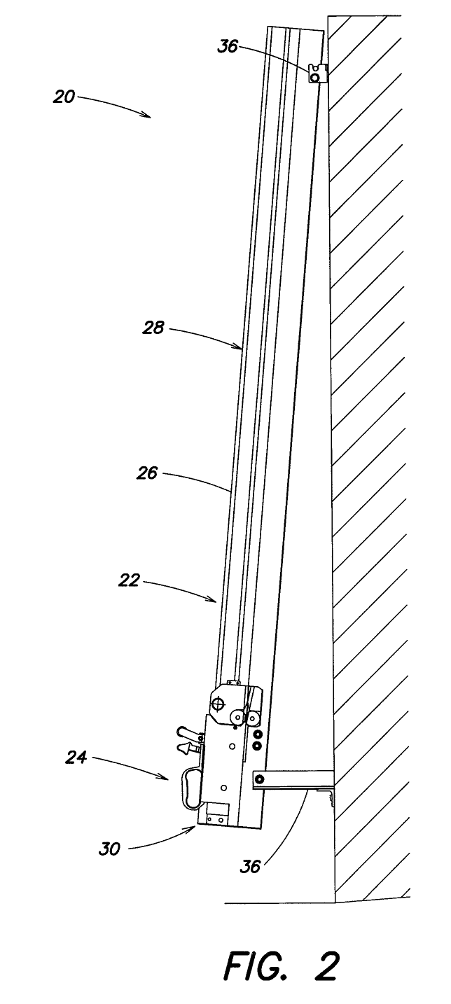

Referring to FIGS. 1 and 2, a device 20 for cutting sheet material is shown that includes a support frame assembly 22 and a cutter head assembly 24 operable to selectively move along a track 26 attached to the support frame assembly 22. The support frame assembly 22 includes a vertical frame assembly 28, a horizontal frame assembly 30, and one or more support panels 32 extending therebetween.

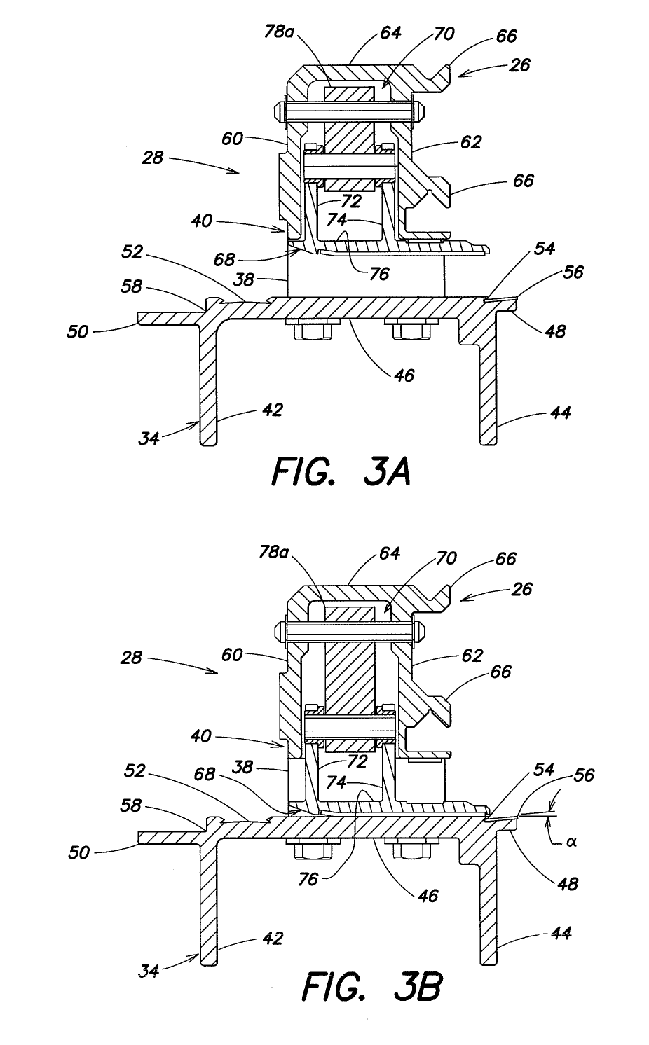

Referring to FIGS. 3A and 3B, the vertical frame assembly 28 includes a vertical frame member 34, a cutter head track 26, a plurality of track spacers 38, and a clamp assembly 40. The term “vertical” as used herein means that the vertical frame assembly 28 is oriented generally perpendicular to the horizontal frame assembly 30 when the device 20 is assembled, and the vertical direction is aligned with a gravity vector. In the detailed description provided herein, the vertical frame member 34 is described and shown as being substantially vertical. The device 20 may, however, be positionally oriented otherwise.

The vertical frame member 34 includes a first leg 42, a second leg 44, a web 46 extending between the first and second legs 42, 44, a break-side flange 48, and a panel-side flange 50. In a preferred embodiment, the vertical frame member 34 has a substantially constant cross-section that permits the member 34 to be extruded. The first and second legs 42, 44 extend outwardly from the web 46. The web 46 includes a channel 52 sized to receive a linear rule. Mounting brackets 36 (see FIG. 2) can be used to attach the vertical frame member 34 to a wall or other structure. Alternative embodiments mount the device on an independent stand. The distance between the vertical frame member 34 and the wall or other structure, can be adjusted to tilt the device 20 to a desired vertical orientation. In some embodiments, the break-side flange 48 includes a channel 54 for receiving a hardened strip insert 56 to protect the break-side flange 48. In a preferred embodiment, the channel 54 is disposed at an angle “α” relative to the web 46 such that an edge of the hardened strip insert 56 is approximately coplanar with the outer surface of the web 46. The hardened strip insert 56 may be secured within the channel 54 by a variety of different mechanisms including tape, adhesive, conventional fastener, etc. The panel-side flange 50 includes a stepped portion 58 for attachment to one or more support panels 32 as will be described below.

The cutter head track 26 is attached to the vertical frame member 34 via spacers 38. The track 26 extends approximately parallel to the vertical frame member 34. Two or more track spacers 38 are disposed between the vertical frame member 34 and the track 26 to space the track 26 apart from, and mount the track 26 to, the vertical frame member 34. The track 26 includes a first leg 60, a second leg 62, and a web 64 extending between the legs 60, 62 to form a substantially U-shaped cross-sectional geometry having an interior defined by the first leg 60, second leg 62, and web 64. In preferred embodiments, the track 26 has a constant cross-sectional geometry that permits it to be extruded. The track 26 further includes a pair of opposing guide flanges 66 extending outwardly from the second leg 62 for guiding the cutter head assembly 24 as will be described below.

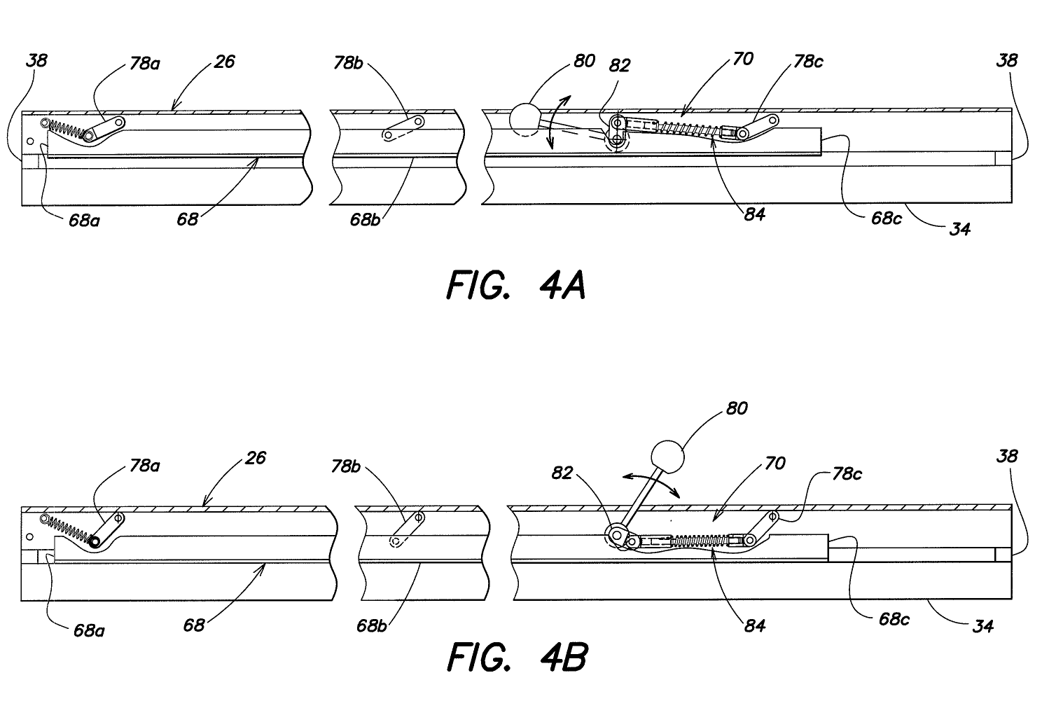

Now referring to FIGS. 3A, 3B, 4A and 4B, the clamp assembly 40 includes a clamp bar 68 and a biasing assembly 70. The clamp bar 68 includes a first leg 72, a second leg 74, and a web 76 extending therebetween and laterally outward from the second leg 74. When assembled, the legs 72, 74 of the clamp bar 68 are received within the interior of the track 26. The clamp bar 68 is attached to the track 26 by a plurality of pivotally mounted links 78a, 78b, 78c that are operable to arcuately pivot the clamp bar 68 between a retracted position adjacent the cutter head track 26, and a deployed position adjacent the vertical frame member 34. The clamp bar 68 remains substantially parallel to the vertical frame member 34 during the travel between the deployed and retracted positions.

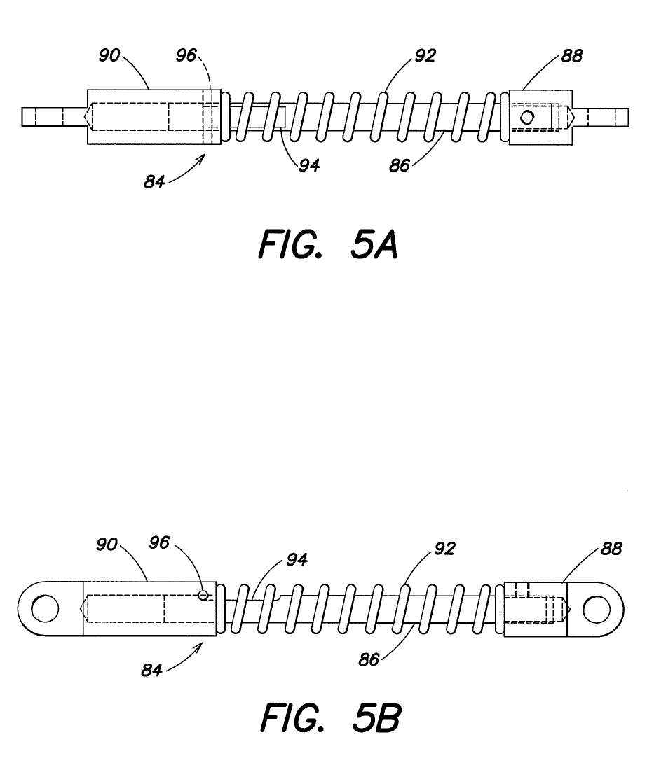

In the embodiment shown in FIGS. 4A, 4B, 5A and 5B, the biasing assembly 70 includes a lever 80, a first link 82 fixed to the lever 80, and a biasing member 84. The biasing member 84 includes a rod 86, a first end flange 88, a second end flange 90, and a coil spring 92. The first end flange 88 is attached to a first end of the rod 86. The second end flange 90 is slidably attached to a second end of the rod 86, opposite the first end of the rod 86. The rod 86 includes a slot 94 disposed adjacent the second end of the rod 86, sized to receive a pin 96. The rod 86 is received within the coil spring 92 and within a portion of the second end flange 90. The rod 86 is connected to the second end flange 90 by the pin 96, which extends through the slot 94. The pin 96 allows the rod 86 and the second end flange 90 to move axially relative to one another without disengaging one another. Axial movement between the rod 86 and the second end flange 90 is limited, however, by the pin 96 contacting the two widthwise ends of the slot 94. The coil spring 92 extends between and acts upon the first and second end flanges 88, 90, thereby biasing the first end flange 88 and attached rod 86 away from the second end flange 90; i.e., toward one end of the permissible travel therebetween. The amount of force provided by the biasing member 84 can be altered by changing the coil spring 92 to one having a different spring rate. The second end flange 90 is pivotally attached to the first link 82 and the first end flange 88 is pivotally attached to the clamp bar 68.

The lever 80, link 82, and biasing member 84 can be rotated into a retracted position as shown in FIG. 4A. From the retracted position, the aforesaid elements can be rotated to a position where the first link 82 and biasing member 84 are axially aligned with one another, and rotated further to a deployed position as shown in FIG. 4B. The deployed position is located a specific rotation angle beyond the axial alignment position (sometimes referred to as an “over the center” position) and thereby creates a detent position where the biasing element 84 holds the elements 80, 82, 84 in place. The force applied by clamp bar 68 via the biasing assembly 70 is greatest when the first link 82 and biasing member 84 are axially aligned with one another, and slightly less in the deployed position. When the biasing assembly 70 is in the deployed position (FIG. 4B), a workpiece can be clamped between the clamp bar 68 and the vertical frame member 34. When the biasing assembly 70 is in the retracted position (FIG. 4A), the clamp bar 68 is disposed in a retracted position away from the workpiece and therefore the vertical frame member 34. The biasing assembly 70 described above is an operable embodiment that provides advantageous clamping and ease of use. The biasing assembly is not limited to this embodiment, however.

In some embodiments, the clamp bar 68 may be slightly crowned in the middle region 68b between ends 68a, 68c. The crown can be created, for example, by a slight curvature of the clamp bar 68, or by a thicker web 76 in the middle region 68b, etc. Alternatively, the crown can be created by causing the clamp bar 68 to deflect slightly in the middle; e.g., by using a link 78b in the middle that is slightly longer than the links 78a, 78c disposed near the end of the clamp bar 68.

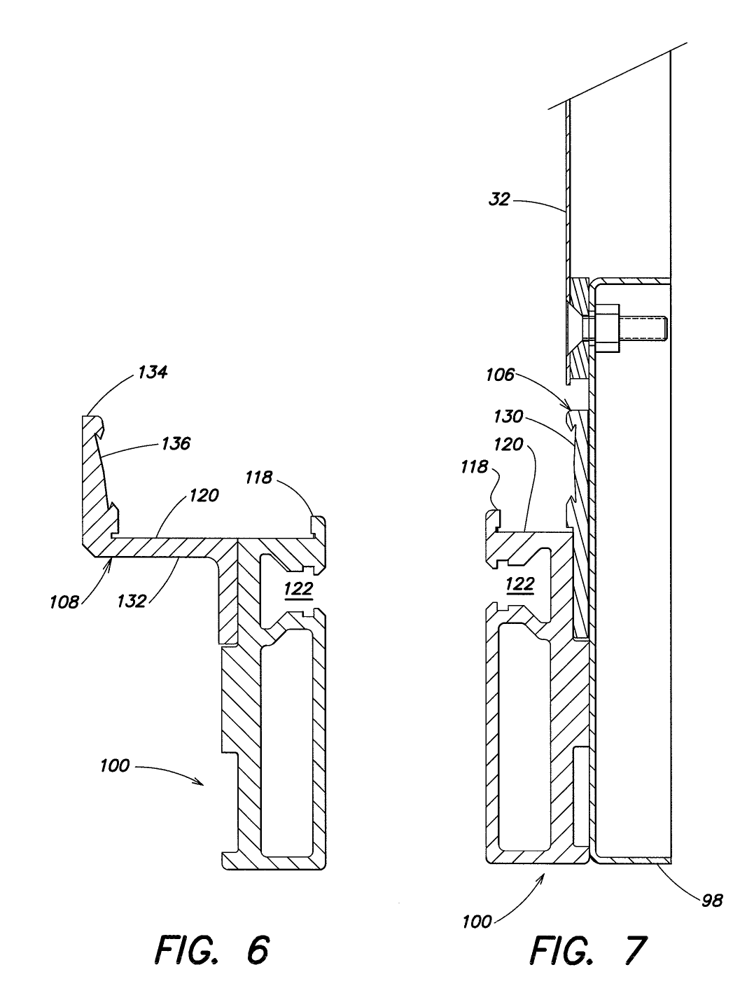

Now referring to FIGS. 1 and 6-8, the horizontal frame assembly 30 includes a static horizontal frame (SHF) member 98, a pivotal horizontal frame (PHF) member 100, an squaring mechanism 102, one or more support legs 104, a support-side tray member 106, and an exit-side tray member 108. The one or more support legs 104 can be adjusted to change the position of the device 20 relative to the floor. The term “horizontal” as used herein means that the horizontal frame assembly 30 is oriented generally perpendicular to the vertical frame assembly 28 when the device 20 is assembled. In the detailed description provided herein, the horizontal frame assembly is described and shown as being substantially horizontal. The device 20 may be positionally oriented otherwise, however.

The SHF member 98 is a C-shaped member that includes a flange attached to one end for attaching the SHF member 98 to the vertical frame member 34. The one or more support legs 104 are attached to the SHF member 98. The one or more support panels 32 extend between and are attached to the SHF member 98 and the vertical frame member 34.

The PHF member 100 is pivotally attached to vertical frame member 34 at a pivot point 112 (see FIG. 1) and can therefore be selectively pivoted relative to the SHF member 98 and the vertical frame member 34. The PHF member may be a single piece that extends along the entire horizontal frame member 30, or it may be sectioned with one section pivotable relative to the vertical frame member 34. One or more fasteners 114 are provided that are operable to fix the PHF member 100 to the SHF member 98. The fastener 114 may be attached to one of the PHF member 100 or the SHF member 98, and travel through a clearance hole or slot in the other of the SHF member 98 or the PHF member 100 to accommodate the relative travel between the members 98, 100. The PHF member 100 includes a ramp surface 116 disposed at or adjacent one end, and a front lip 118 extending outwardly from a top surface 120. In a preferred embodiment, the PHF member 100 has a constant cross-section that permits it to be extruded. The PHF member 100 includes a channel 122 for receiving workpiece positional stops.

The support-side tray member 106 attaches to the PHF member 100 on one side (e.g., the left side facing the device 20) of the vertical frame member 34. The support-side tray member 106 extends away from the PHF member 100 in a direction that is substantially parallel to the front lip 118 of the PHF member 100, thereby forming a channel with the front lip 118 and the top surface 120. The support-side tray member 106 may include a slot 130 for receiving a linear rule. The exit-side tray member 108 attaches to the PHF member 100 on the opposite side (e.g., the right side facing the device 20) of the vertical frame member 34. The exit-side tray member 108 includes a first portion 132 that extends away from the PHF member 100 in a direction that is coplanar with the top surface 120 of the PHF member 100, and a second portion 134 that is substantially parallel to the front lip 118 of the PHF member 100 thereby forming a channel with the front lip 118, top surface 120, and first portion 132. The second portion 134 of the exit-side tray member 108 may include a slot 136 for receiving a linear rule.

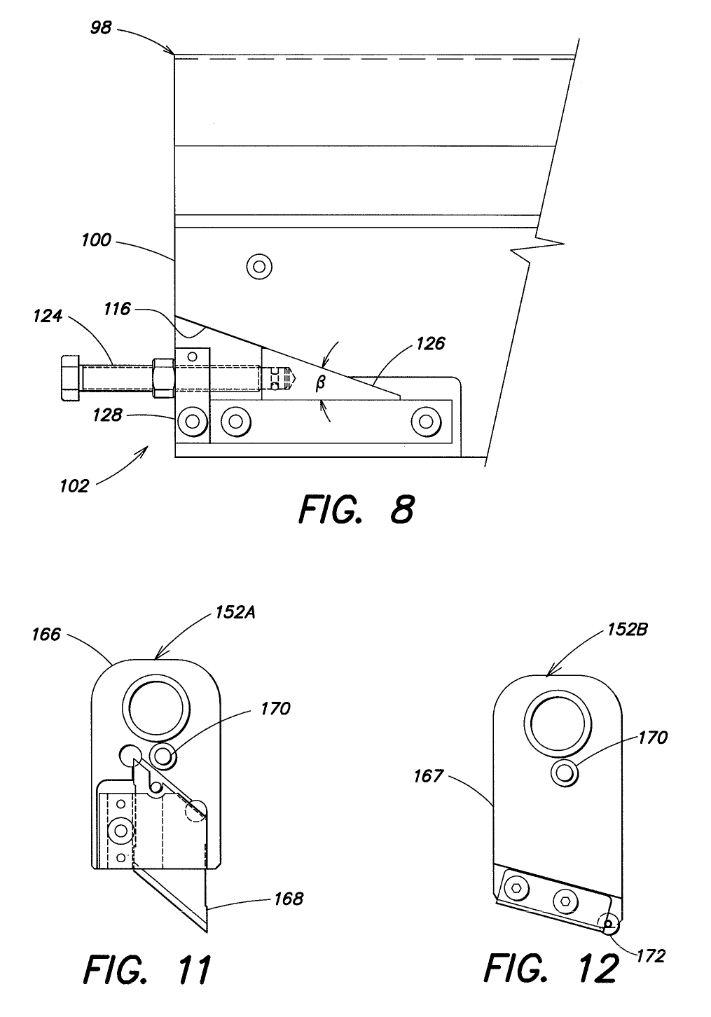

Now referring to FIGS. 1 and 8, the squaring mechanism 102 (also referred to as an angle adjustment mechanism) includes a threaded member 124 pivotally attached to a wedge 126 (e.g., triangular-shaped), and a threaded flange 128. The threaded member 124 is in threaded engagement with the flange 128 (or a nut attached thereto). Rotation of the threaded member 124 is operable to laterally move the wedge 126. The wedge 126 is positioned in contact with the ramp surface 116 of the PHF member 100. Movement of the wedge 126 causes the PHF member 100 to rotate relative to the vertical frame member 34. The rate at which the PHF member 100 rotates relative to the vertical frame member 34 is dictated by the angle “β” of the triangular wedge 126 and the thread per unit length (e.g., coarse thread, fine thread, etc.) of the threaded member 124. The squaring mechanism 102 can be used to set the PHF member 100 perpendicular to the vertical frame member 34, or at some other desired angle.

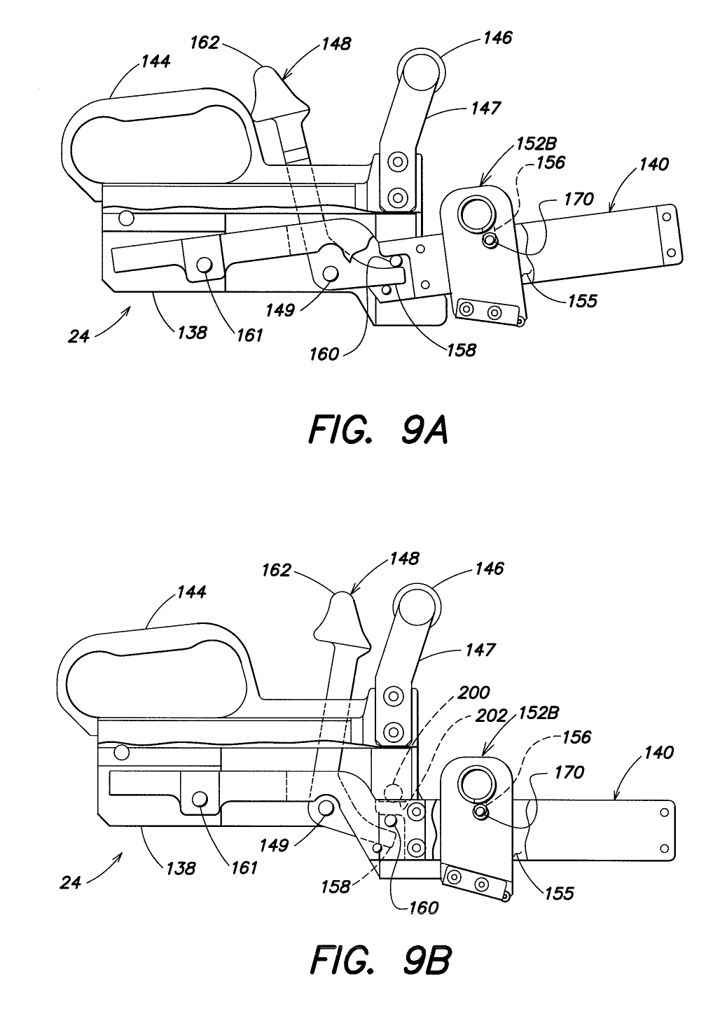

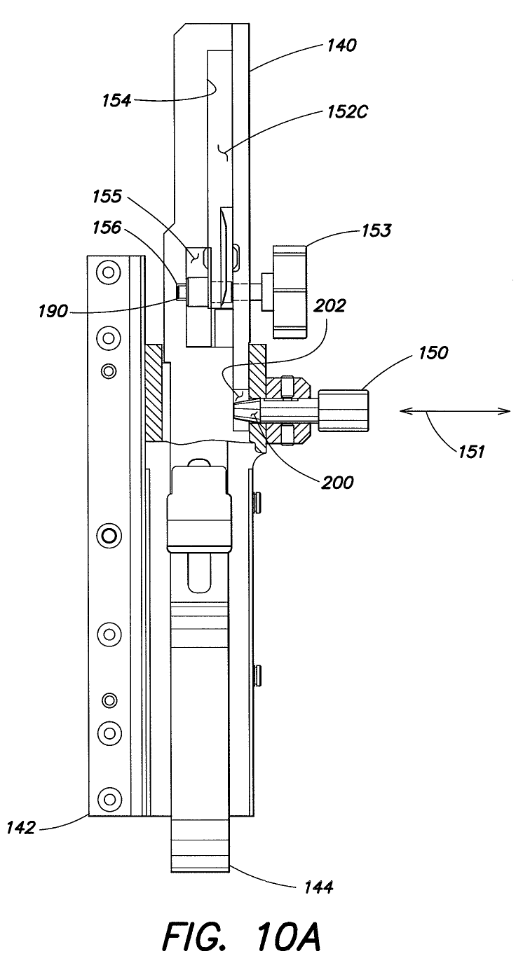

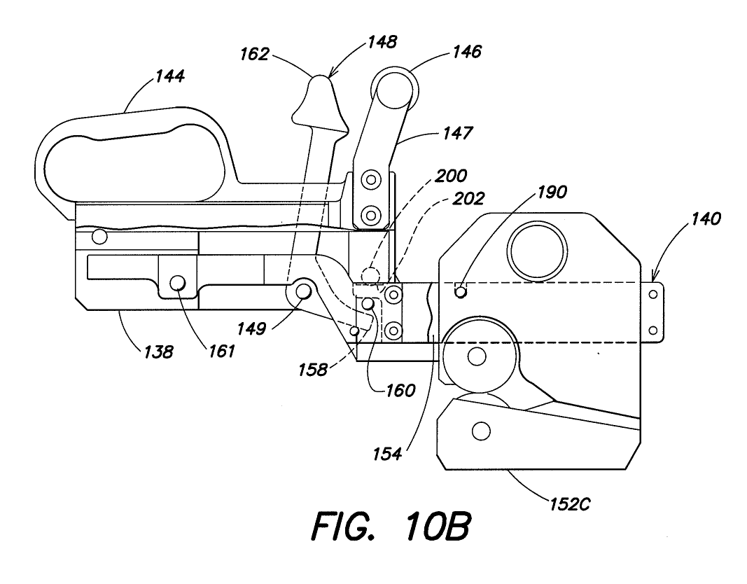

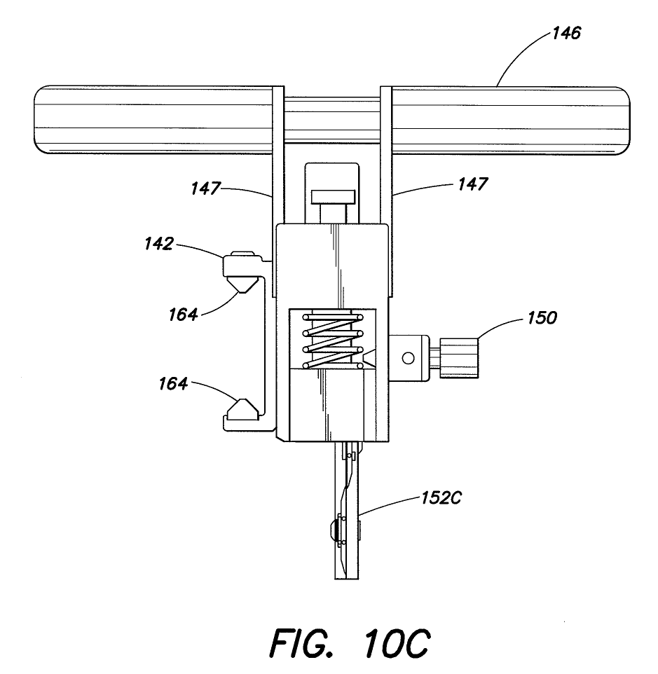

Now referring to FIGS. 9A, 9B, 10A, 10B, and 10C, the cutter head assembly 24 includes a frame 138, a cartridge support arm 140, a track guide 142 (see FIG. 10C), a first handle 144, a second handle 146, a cartridge lift lever 148, a lock screw 153, and a cartridge 152A, 152B, 152C. As will be explained below, there are a variety of different cartridge embodiments that can be used with the cutter head assembly 24. Cartridges 152A, 152B, and 152C represent examples of acceptable cartridges. The first handle 144 is attached to the frame 138. In the embodiment shown in FIGS. 9A, 9B, 10B, and 10C, the first handle 144 is integrally formed with the frame 138. The second handle 146 (not shown in FIG. 10A), which is attached to the frame 138 by a pair of brackets 147, extends laterally outward from the frame 138; i.e., extends out from the frame 138 in a direction that is substantially perpendicular to the travel direction of the cutter head assembly 24. The lock screw 153 (see FIG. 10A), which is threadably engaged with the support arm 140, can be used to selectively fix a cartridge 152A, 152B, 152C within the support arm 140. Alternatively, the cartridge can be permitted to float within the support arm 140 pocket.

The cartridge support arm 140 is pivotally attached to the frame 138 to allow the cartridge 152 to be positioned in a deployed position (FIG. 9B) or a retracted position (FIG. 9A). A spring is disposed within the frame 138 to bias the cartridge support arm 140 in the deployed position. A pin 150 slidably engaged with the frame 138 (along the axis of arrow 151—see FIG. 10A) can be positioned to maintain the cartridge support arm 140 in the deployed position or in the retracted position. In a preferred embodiment, the pin 150 has a tapered portion 200 located at its distal end (see FIG. 10A; also shown in phantom in FIGS. 9B and 10B), and a portion of the support arm 140 has a matching tapered surface 202 (see FIGS. 9A and 10A). The tapered surface 202 of the support arm 140 is positioned to align with the tapered portion 200 of the pin 150 when the support arm 140 is located in the deployed position. FIGS. 9B and 10B diagrammatically show the tapered portion 200 of the pin 150 engaged with the tapered surface 202 when the support arm 140 is in the deployed position. The tapered surfaces 200, 202 facilitate alignment between the pin 150 and the support arm 140, and thereby facilitate engagement of the pin 150 with the support arm 140. The cartridge support arm 140 includes one or more pockets 154, 155 for receiving one or more different cartridges 152A, 152B, 152C. In some embodiments, one or more slots 156 are disposed in the wall of the pocket 154, 155 to receive a locating post 170, 190 as will be explained below.

The cartridge lift lever 148 is pivotally attached to the frame 138. A first end 158 of the lift lever 148 is positioned for engagement with a post 160 attached to the support arm 140. The second end 162 of the lift lever 148 extends toward a position adjacent the first handle 144. If the second end 162 of the lift lever 148 is pulled toward first handle 144, the lift lever 148 will pivot about axle 149 and the first end 158 of the lift lever will contact the post 160. If the lift lever 148 is drawn further toward the first handle 144, the lift lever 148 will cause the cartridge support arm 140 to rotate about axle 161, thereby moving the cartridge support arm 140 into the retracted position. Other mechanisms for pivoting the cartridge support arm 140 may be used alternatively.

Referring to FIG. 10C, the track guide 142 is a C-shaped member that is attached to one side of the frame 138. A pair of opposing guide elements 164 is attached to the interior of the track guide 142. The guide elements 164 are shaped and spaced apart from one another to form a mating pair with the opposing guide flanges 66 extending outwardly from the cutter head track 26. The guide elements 164 form a slide fit with the opposing guide flanges 66 to permit the cutter head assembly 24 to be moved linearly along the cutter head track 26.

The cartridge can assume a variety of different forms (e.g., 152A, 152B, 152C) operable to cut a variety of different materials. In the embodiment shown in FIG. 11, the cartridge 152A includes a frame 166 and a cutting blade 168 statically mounted relative to the cartridge 152A. The blade 168 is attached to the cartridge 152A in a predetermined position, such that at least a portion of a cutting edge of the blade 168 extends outside the frame 166. The frame 166 includes a locating post 170 attached to the frame 166, extending outwardly from the frame 166. The locating post 170 is positioned to align with the slot 156 disposed in the pocket 155 in the cartridge support arm 140 (see FIGS. 9A and 9B). The locating post 170 and slot 156 ensure the cartridge 152A is properly positioned within the pocket 155, and therefore relative to the cutter head assembly 24.

Now referring to FIG. 12, an alternative cartridge 152B includes a glass scoring wheel 172 pivotally mounted to the frame 167 of the cartridge 152B. In this embodiment, the glass scoring wheel 172 is operable to be placed on a surface of a pane of glass. In alternative embodiments, a single rotary cutter wheel may be used in place of the glass scoring wheel 172.

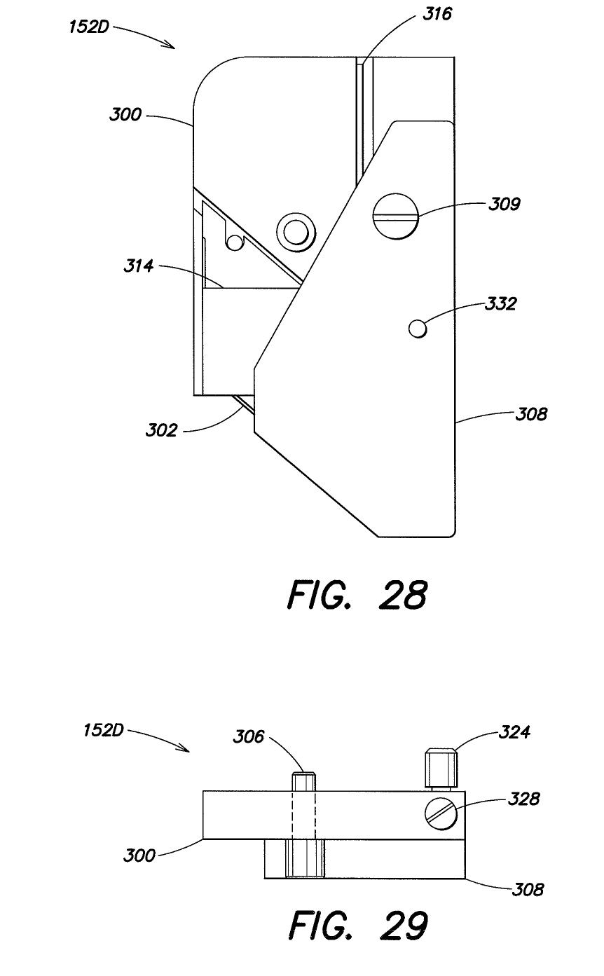

Now referring to FIGS. 28-31, in another embodiment, the cartridge 152D includes a frame 300, a first cutting blade 302, a second cutting blade 304, a locating post 306, and optionally a safety guard 308. The cutting blades 302, 304 are substantially co-planar with one another, and are statically mounted relative to the frame 300. The first cutting blade 302 is positioned forward of the second cutting blade 304. The term “forward” is used here to indicate the relative positions; i.e., when the cutter head assembly 24 is drawn across a workpiece to cut the same, the forwardly positioned first cutting blade 302 will engage the workpiece before the second cutting blade 304. Each cutting blade 302, 304 has a blade exposure distance 310, 312. In the embodiment shown in FIGS. 28-31, the first and second cutting blades 302, 304 are the same size. The mounting positions of the first and second cutting blades 302, 304, however, are such that the blade exposure distance 310 of the first cutting blade 302 is less than the blade exposure distance 312 of the second cutting blade 304. As a result, the first cutting blade 302 is operable to make a first depth of cut within the workpiece and the co-planar second cutting blade is operable to make a second depth of cut. The example shown in FIGS. 28-31 illustrates some overlap in depth of cut between the cutting blades 302, 304. A plate 314 fastened to the frame 300 can be used to secure the cutting blades 302, 304 to the frame 300.

An advantage of the aforesaid double blade arrangement is that it can be used to create a substantial depth of cut in a manner that does not utilize a single unsupported blade. Forces applied to a single, thin cutting blade during operation can cause the blade to deflect and possibly fail. The present arrangement avoids that problem by using two blades, each of which cuts less than one single blade would cut. Another advantage of the double blade arrangement is that it facilitates cutting substrates having a surface veneer with different shear characteristics than the remainder of the substrate; e.g., a foam board with kraft paper veneer and a polystyrene core. In some embodiments, the first cutting blade 302 may be different from the second cutting blade 304 (e.g., made of a different material, different geometric characteristics, etc.) that make it better suited to cutting the veneer versus the second cutting blade 304 cutting the substrate core.

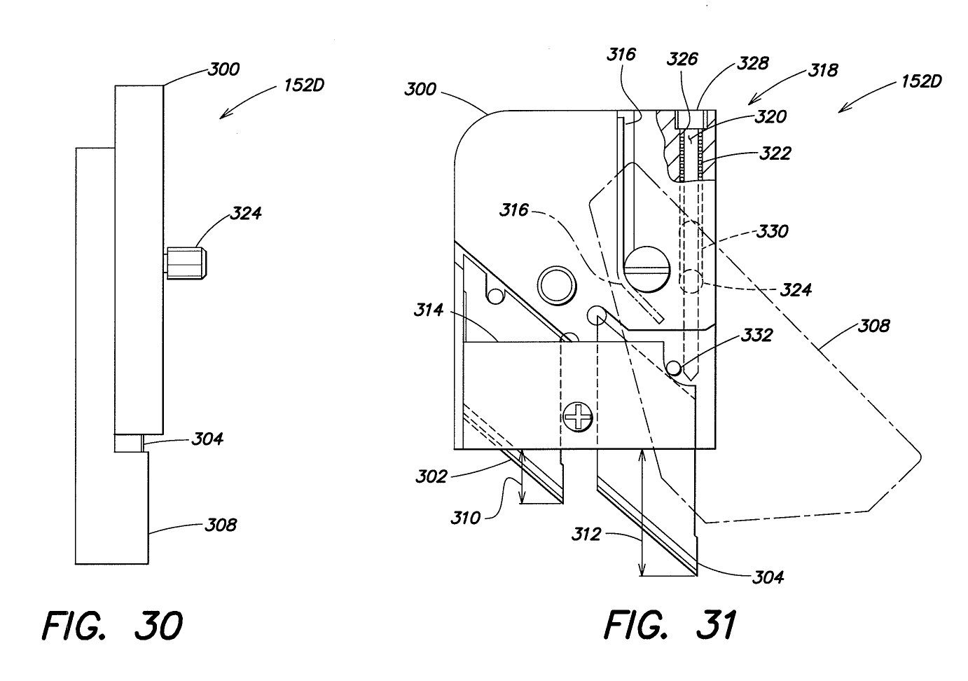

The safety guard 308 is pivotally mounted to the frame 300 at a pivot point 309, and is biased in a deployed position by a spring 316. The safety guard 308 at least partially covers the cutting blades 302, 304, and is positioned to engage the workpiece prior to the cutting blades 302, 304 engaging the workpiece. Engaging the workpiece causes the guard 308 to pivot away from, and thereby expose the blades 302, 304, enabling the blades to be drawn into contact with the workpiece. The guard 308 is shown by phantom line in a blade exposed position in FIG. 31. After the cutter head assembly 24 is drawn across and is free from the workpiece, the safety guard 308 returns to its deployed position.

In some embodiments, the cartridge 152D include a safety guard lock that includes a spring mounted lock pin assembly 318 partially disposed within the frame 300. The pin assembly 318 includes a slide 320, a spring 322, and a post 324 attached to the slide 320. The spring 322 biases the slide 320 toward one end of a bore 326 disposed within the frame 300. A set screw 328 holds the slide 320 and spring 322 within the frame 300. The post 324 extends out from the bore 326 through a slot 330 disposed in the frame 300. The spring 322 normally maintains the post 324 at one end of the slot 330, and the slide 322 in a position wherein the safety guard 308 is locked into the deployed position. In the “locked” position, the slide 320 is positioned to interfere with a pin 332 fixed within the safety guard 308. The interference prevents rotation of the guard 308. Actuating the post 324 within the slot 330 in the opposite direction causes the slide 320 to linearly travel within the bore 326 an amount that prevents the slide 320 from interfering with the pin 332 as the guard 308 rotates; i.e., the “unlocked” position.

When the cartridge 152D is fully inserted into the cartridge support arm 140, the lock pin assembly 318 is moved into the unlocked position, thereby enabling the safety guard 308 to be pivoted during use. The lock pin assembly 318 is moved to the unlocked position by the post 324 engaging a top surface 334 of the cartridge support arm 140 as the cartridge 152D is inserted into the cartridge support arm 140. As the cartridge 152D is inserted further into the support arm 140, the post 324 is actuated relative to the slot 330, and the slide 320 is moved out of interference with the pin 332 in the guard 308. Lock screw 153 (e.g., see FIG. 10A) is operable to hold the cartridge 152D in place. When the cartridge 152D is disposed outside the cutter head assembly 24, the slide 320 is biased in the locked position to protect the blades 302, 304 and protect against accidental contact.

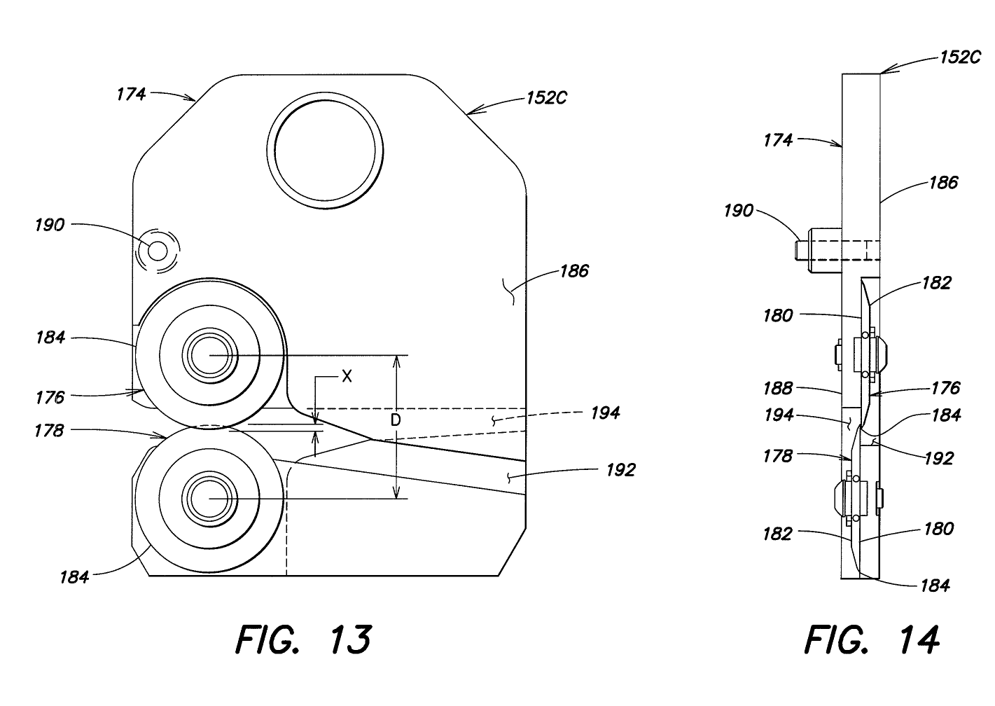

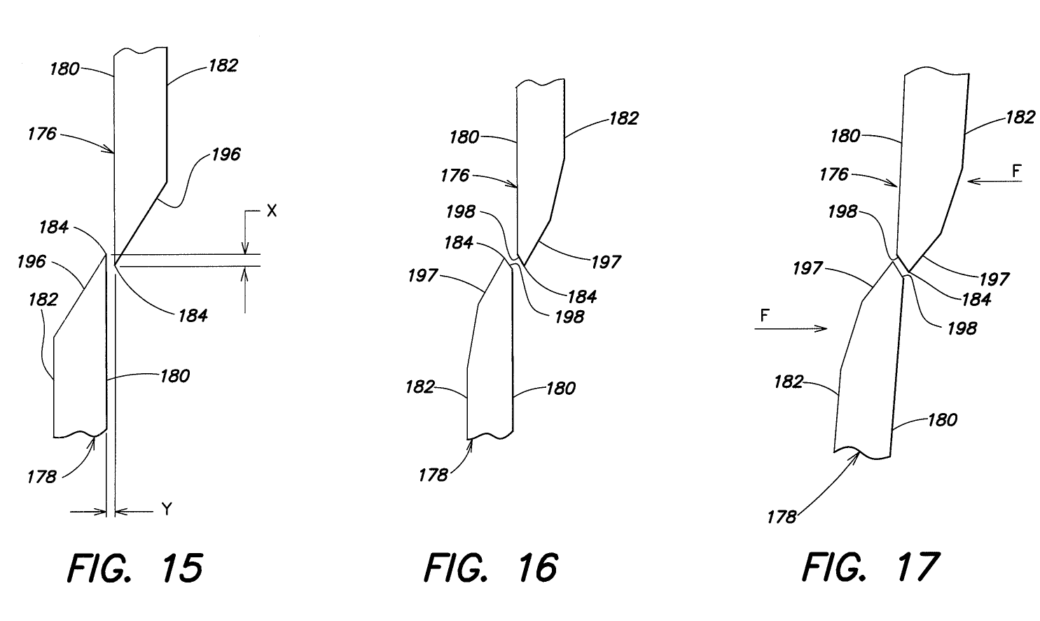

Now referring to FIGS. 13 and 14, in another embodiment, the cartridge 152C includes a frame 174, a first rotary cutter wheel 176, and a second rotary cutter wheel 178. Each cutter wheel 176, 178 has an inner surface 180, an outer surface 182, and a cutting edge 184. The first rotary cutter wheel 176 is disposed on a first side 186 of the frame 174. The second rotary cutter wheel 178 is disposed on a second side 188 of the frame 174 opposite the first side 186. The cutter wheels 176, 178 are mounted on independent axes separated from one another by a predetermined distance “D”. In some embodiments, the distance “D” is chosen to create a radial overlap of magnitude “X” between the cutter wheels 176, 178. The cutter wheels 176, 178 are also spaced on the independent axes to create a lateral separation distance “Y” between cutter wheels 176, 178 (see FIG. 15). The lateral separation distance “Y” can be defined as the distance between chosen similar surfaces of the cutter wheels 176, 178; e.g., the distance between the cutting edges 184, or between the inner surface 180 of each cutter wheel 176, 178, etc. The lateral separation distance “Y” can be accurately created by tolerancing, or shims, etc. Each cutter wheel 176, 178 is preferably mounted on a bearing to facilitate rotation about a defined axis, and minimize wobble of the cutter wheel 176, 178 relative to the axis.

The cartridge frame 174 also includes a locating post 190 attached to the frame 174, extending outwardly from the frame. The locating post 190 is positioned to align with the slot 156 disposed in the pocket 155 within the cartridge support arm 140. The locating post 190 and slot 156 ensure the cartridge 152 is properly positioned within the pocket 154. In some embodiments, the slot 156 has a depth that allows the locating post 190, and therefore the cartridge 152, to float within the slot to facilitate alignment with the workpiece.

The cartridge 152 may further include a first workpiece channel 192 disposed in the first side 186 of the frame 174, and a second workpiece channel 194 disposed in the second side 188 of the frame 174. The workpiece channels 192, 194 are positioned to receive portions of the workpiece sheared by the cutter wheels 176, 178 as will be explained below. The depth of each workpiece channel 192, 194 is chosen such that sheet material portion exiting the cutter wheels 176, 178 readily passes into the workpiece channel 192, 194.

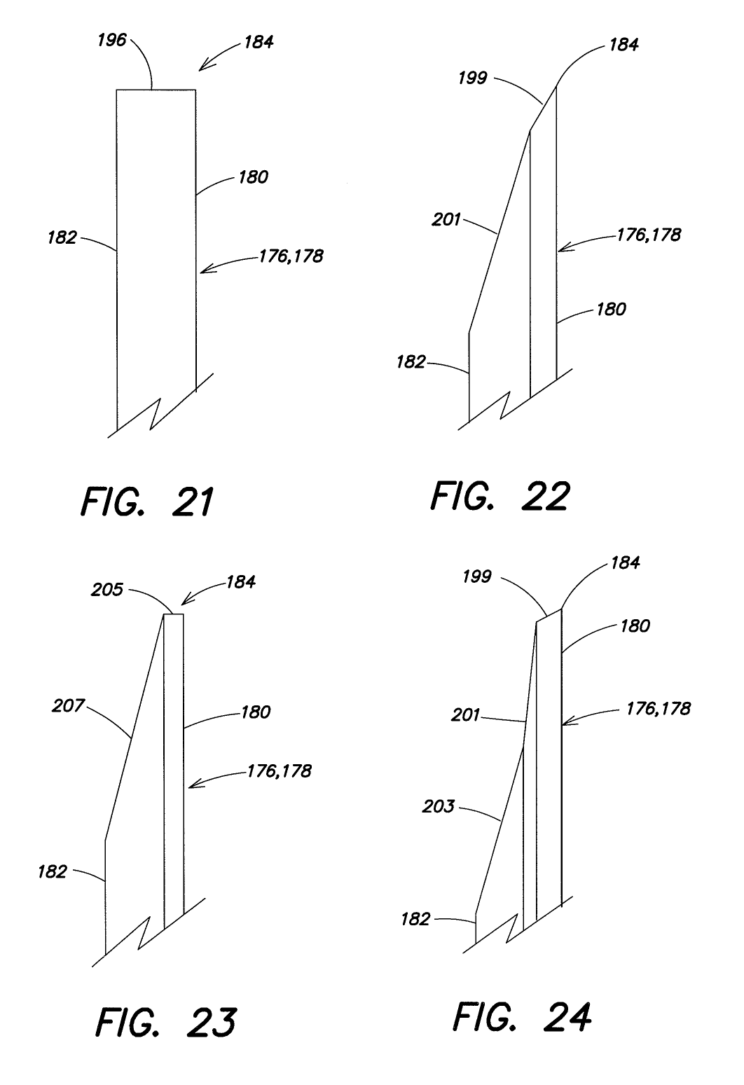

Referring to FIGS. 15-17 and 21-24, the cutter wheel may assume a variety of geometries advantageous for different applications. In the embodiments shown in FIGS. 15 and 21, the cutting edge 184 of a cutter wheel 176, 178 is defined by one edge surface 196 that extends between the inner surface 180 and the outer surface 182. As shown in FIG. 15, the single edge surface 196 extends between the inner and outer surfaces 180, 182 at an angle skewed from the rotational axis of the cutter wheel 176, 178. In FIG. 21, the edge surface 196 extends along a line parallel to the rotational axis of the cutter wheel 176. In other embodiments, the cutting edge 184 may be defined by a plurality of surfaces disposed between the inner and outer surfaces 180, 182. For example, in FIGS. 16 and 17, the cutting edge 184 is defined by a first edge surface 197 and a second edge surface 198. The first edge surface 197 is disposed between the outer surface 182 and the cutting edge 184, and the second edge surface 198 is disposed between the inner surface 180 and the cutting edge 184. In some embodiments, the cutter wheel 176, 178 may include edge and relief surfaces disposed between the inner surface 180 and the outer surface 182. In FIGS. 22 and 24, the cutting edge 184 is disposed between the inner surface 180 and an edge surface 199. In FIG. 22, a relief surface 201 is disposed between edge surface 199 and the outer surface 182. In FIG. 24, a pair of relief surfaces 201, 203 are disposed between edge surface 199 and the outer surface 182. The cutter wheel embodiment 176, 178 shown in FIG. 23, includes a cutting edge 184 defined by edge surface 205 extending parallel to the rotational axis of the cutter wheel 176, 178 and a relief surface 207 disposed between the edge surface 205 and the outer surface 182. The diagrammatic views of FIGS. 16 and 17 are exaggerated to better illustrate the cutting edge embodiments. The cutting wheels 176, 178 and the cutting edges 184 defined therein are not limited to these exemplary embodiments.

The following examples are provided to illustrate the utility of the present device 20 for cutting sheet material.

### EXAMPLE I

The present device 20 for cutting sheet materials can be used for cutting mat board commonly used in the process of picture framing. The device 20 is mounted against a wall surface (or independently via a stand) at an appropriate work height and angle by adjusting the bracketry and support leg 104 (or stand). The angle between the PHF member 100 and the vertical frame member 34 is adjusted by actuating the squaring mechanism 102. For example, a squaring mechanism 102 having a wedge 126 with a ramp angle of approximately 20 degrees, and a threaded member 124 having ⅜ inch-24 UNF thread, will provide a vertical change of approximately 0.015 inches per revolution of the threaded member 124. The magnitude of the change in angle of the workpiece relative to the cutter head track 26 will, however, depend on the position of the squaring mechanism 102 relative to the pivot point 112 of the PHF member 100. The cutter head assembly 24 can be positioned to permit a matboard to be inserted into the device 20 by moving the assembly 24 along the track 26 to an upper position.

Once the PHF member 100 and the vertical frame member 34 are square with one another and the cutter head assembly 24 is located out of the way, the matboard is inserted between the clamp bar 68 and the vertical frame member 34. The matboard can be positioned relative to the cutter head assembly 24 using the linear rules provided in the support-side tray member 106, the exit-side tray member 108, and/or the vertical frame member 34.

With the matboard properly positioned, the clamp assembly 40 is actuated from the retracted position to the deployed position. In the deployed position, the biasing assembly 70 biases and maintains the clamp bar 68 in contact with the matboard, thereby clamping it against the vertical frame member 34. The matboard will remain clamped without further action from the operator until the clamp assembly 40 is actuated into the retracted position (i.e., the operator himself is not required to maintain clamp pressure).

In this example, the cutter head assembly 24 utilizes the cartridge 152A having a statically mounted cutting blade 168. The cutter head assembly 24 is moved so that the cutting blade 168 contacts the matboard, and then is subsequently drawn across the matboard to perform the cut. Once the cut is made, the cutter head assembly 24 is secured out of the way, the clamping assembly 40 is actuated into a retracted position, and the matboard is removed from the device 20, or shifted to a new desired position.

Examples of other sheet materials that can be cut with the present device 20 using a cartridge 152A with a static cutting blade 168, include PVC, foamboard, wood veneer, corrugated vinyl, etc.

### EXAMPLE II

The present device 20 for cutting sheet materials can also be used to cut diebond (i.e., corrugated panels including outer layers consisting of sheet metal), which is commonly used for signage. The device 20 is mounted similar to the manner described above under Example I.

Once the PHF member 100 and the vertical frame member 34 are square with one another and the cutter head assembly 24 is located out of the way, the diebond sheet is inserted between the clamp bar 68 and the vertical frame member 34. The diebond sheet can be positioned relative to the cutter head assembly 24 using the linear rules provided in the support-side tray member 106, the exit-side tray member 108, and/or the vertical frame member 34. With the diebond sheet properly positioned, the clamp assembly 40 is actuated from the retracted position to the deployed position. In the deployed position, the biasing assembly 70 biases and maintains the clamp bar 68 in contact with the diebond, thereby clamping it against the vertical frame member 34.

In this example, the cutter head assembly 24 utilizes the cartridge 152C having rotary cutter wheels 176, 178. The cutter head assembly 24 is moved so that the diebond sheet is drawn between the rotary cutter wheels 176, 178 and the assembly 24 is subsequently drawn across the diebond sheet to perform the cut. In some embodiments, the cartridge 152C is mounted to “float” within the cutter assembly 24 to facilitate alignment between the rotary cutter wheels 176, 178 and the diebond workpiece. As the diebond sheet passes through the rotary cutter wheels 176, 178, one of cut sheet portions is guided within the first workpiece channel 192 in a first direction and the other cut sheet portion is guided within the second workpiece channel 194 in a second direction away from the first direction. Once the cut is made, the cutter head assembly 24 is secured out of the way, the clamping assembly 40 is actuated into a retracted position, and the diebond sheet is removed from the device 20.

Examples of other sheet materials that can be cut with the present device 20 using a cartridge 152C with rotary cutter wheels 176,178 include sheet metal, alumalite, etc.

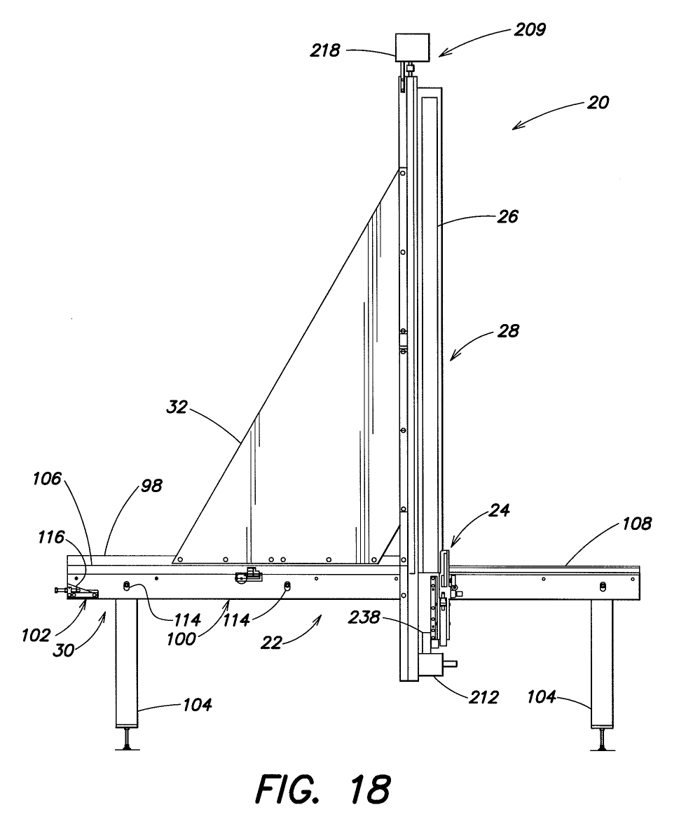

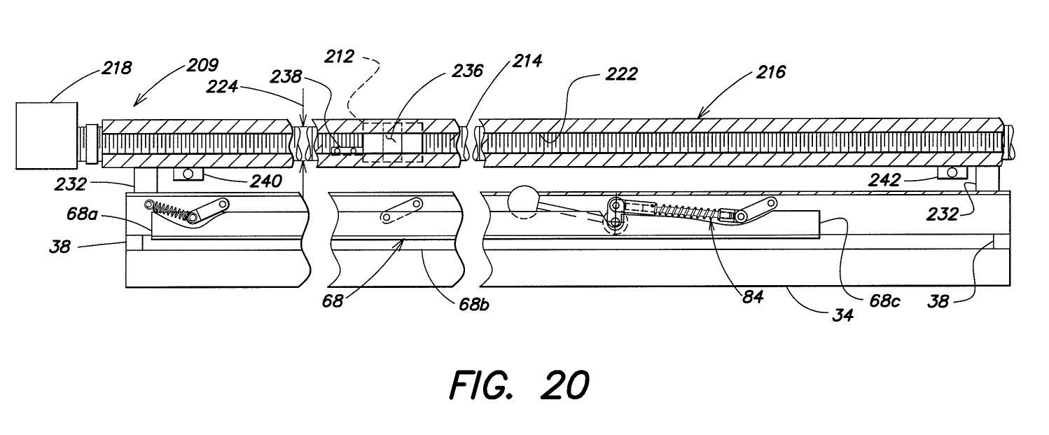

Now referring to FIGS. 18-20, in an alternative embodiment, the device 20 includes a linear drive unit 209 operable to power the cutter head assembly 24 along the cutter head track 26. The linear drive unit 209 may provide power via a fluid cylinder, or by a motor coupled with a flexible member (e.g., a chain, cable, or belt), or a linear gear (e.g., a rack and pinion), or a threaded member coupled with a linear slide, or combinations thereof. The drive unit includes a controller that enables operator control of the cutter head assembly 24 along substantially all of the length of the cutter head track 26, or portions thereof, in both directions. Operator input to the controller may occur by electrical controls (e.g., switches, CPU, etc.) hardwired to the controller, or by radio operated wireless controls, or some combination thereof. The drive unit 209 may also include safety controls operably connected to the controller to prevent predetermined operating conditions.

In a drive unit 209 embodiment that includes a fluid cylinder, the fluid cylinder may, for example, be a pneumatic cylinder that has a cylinder housing and a double-acting rod. In most applications, the actuable length of the rod is equal to or greater than the travel of the cutter head assembly 24 on the cutter head track 26. The cylinder housing may be attached to the either the cutter head track 26 or the vertical frame member 34. The rod is attached to the cutter head assembly 24. The controller may be appropriate pneumatic valving that permits the operator to control actuation of the rod into and out of the cylinder housing, thereby moving the cutter head assembly 24 along the cutter head track 26.

In a drive unit 209 embodiment that includes a motor driven flexible member, the flexible member may be in the form of a chain, cable, belt, or the like, arranged in a closed loop. An electrical drive motor and drive pulley (or drive gear) is disposed adjacent one end of the cutter head track 26, and a non-driven pulley (or gear) is disposed adjacent the other end of the cutter head track. The flexible member is attached to the cutter head assembly 24. Rotating the drive pulley clockwise causes the cutter head assembly to be drawn along the cutter head track in a first direction. Rotating the drive pulley counterclockwise causes the cutter head assembly to be drawn along the cutter head track in a second direction, opposite the first direction.

In a drive unit 209 embodiment that includes a linear gear, a gear mounted on a motor may be engaged with a linear gear. The linear gear is attached to the cutter head assembly 24. Rotation of the motor mounted gear clockwise causes the cutter head assembly 24 to be drawn along the cutter head track 26 in a first direction. Rotating the motor mounted gear counterclockwise causes the cutter head assembly 24 to be drawn along the cutter head track 26 in a second direction, opposite the first direction.

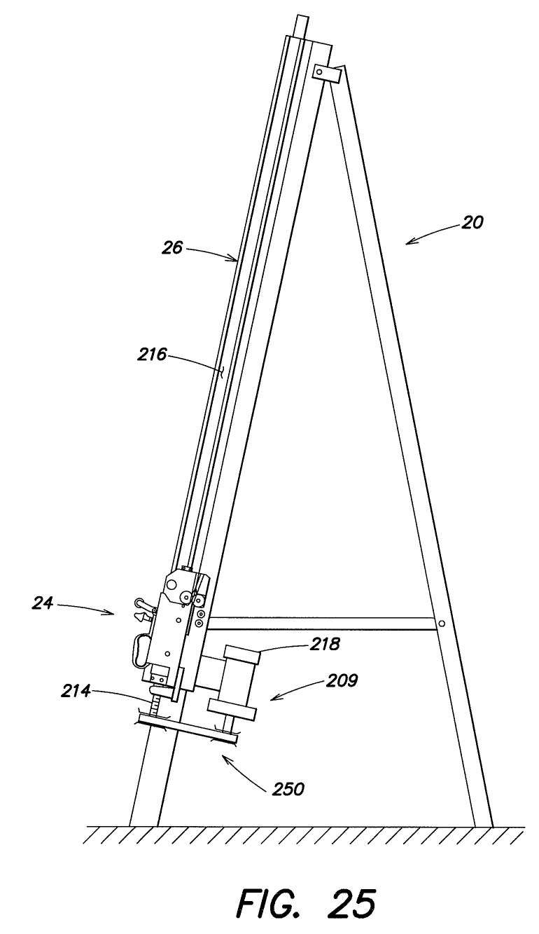

In a drive unit 209 embodiment that includes a threaded member assembly coupled with a linear slide 212, the threaded member assembly includes a screw 214 disposed within a guide rail 216. The screw 214 may be a one piece unit or a plurality of connected sections that collectively have a length that is, in most applications, equal to or greater than the travel of the cutter head assembly 24 on the cutter head track 26. One end of the screw 214 is coupled (see FIG. 18) to a motor 218 that is operable to rotate the screw 214 clockwise and counterclockwise. Alternatively, the motor 218 may be engaged with the screw 214 by a belt or chain and pulley arrangement 250 (see FIG. 25).

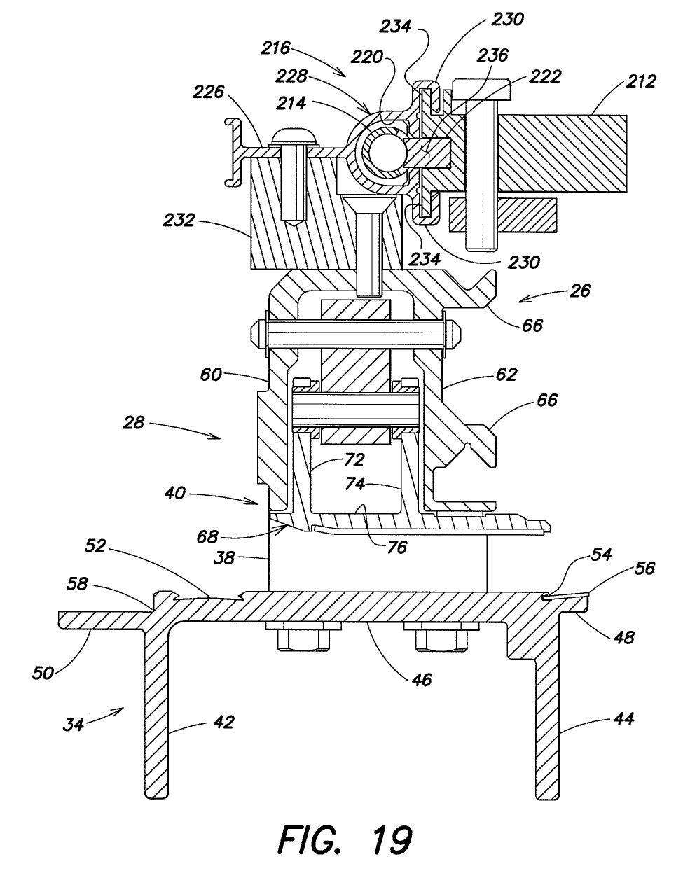

The guide rail 216 includes a cylindrical bore 220 (see FIG. 19) having an internal diameter large enough to receive the outer diameter of the screw 214 with a slide fit therebetween. The internal diameter surface of the cylindrical bore 220 may include a wear-resistant surface applied directly to the cylindrical bore 220, or a wear-resistant liner may be disposed within the cylindrical bore 220. The guide rail 216 includes a window 222 that permits access to cylindrical bore 220. The window 222 extends continuously along substantially the entire length of the cylindrical bore 220. The window 222 has a width 224 great enough to permit engagement of the screw 214, but small enough to prevent the screw 214 from exiting the cylindrical bore 220 through the window 222.

In the embodiment shown in FIGS. 18-20, the guide rail 216 includes a rib 226, a screw housing 228 containing the cylindrical bore 220, and a pair of opposed u-shaped slide flanges 230. The rib 226 is attached to a first side of the screw housing 228, and the pair of opposed u-shaped flanges 230 are attached to a second side of the screw housing 228, substantially opposite the first side. The window 222 is disposed within the screw housing 228, located between the u-shaped flanges 230.

The guide rail 216 may be attached to, or incorporated within, the cutter head track 26 or the vertical frame member 34. In the embodiment shown in FIGS. 18-20, the guide rail 216 is shown attached to the cutter head track 26. The present invention is not limited to this embodiment, however. A plurality of spacer blocks 232 separate the cutter head track 26 from, and maintain it parallel to, the guide rail 216.

The linear slide 212 includes a flange 234 sized to be received within the u-shaped flanges 230 of the guiderail 216, a selectively engageable member 236, and a flange 238 for attachment to the cutter head assembly 24. The selectively engageable member 236 includes a threaded section that mates with the thread of the screw 214. It can be selectively engaged with the screw 214 through the window 222 within the screw housing 228. Once engaged, the slide 212 can only be moved along the guide rail 216 (and therefore the cutter head track 26) by rotation of the screw 214. When disengaged, the slide 212 can be freely moved along the guide rail 216 (and therefore the cutter head track 26).

An upper limit switch 240 is attached to the guide rail 216 at a position intended to be the maximum upper position of the slide 12 (and therefore the cutter head assembly 26). Likewise, a lower limit switch 242 is attached to the guide rail 216 at a position intended to be the maximum lower position of the slide 216. A limit switch engagement arm is attached to the slide 216 to actuate the limit switches 240, 242 at the appropriate travel position. The limit switches 240, 242 are electrically connected to the controller to stop the electrical motor 218. Alternative embodiments may use different travel sensors such as rotary encoders, etc.

In the operation of the device 10, the operator positions the cutter head assembly 24 above a workpiece prior to making the cut. Once the workpiece is positioned and clamped, the operator starts the drive unit, which in turn begins to drive the cutter head assembly 24 downward along the cutter head track 26. The workpiece is engaged by the cartridge 152 within the cutter head assembly 24 and is cut as the cutter head assembly 24 travels along the cutter head track 26. After the cutter head assembly 24 has finished the cut, it will continue to travel until the lower limit switch 242 is actuated.

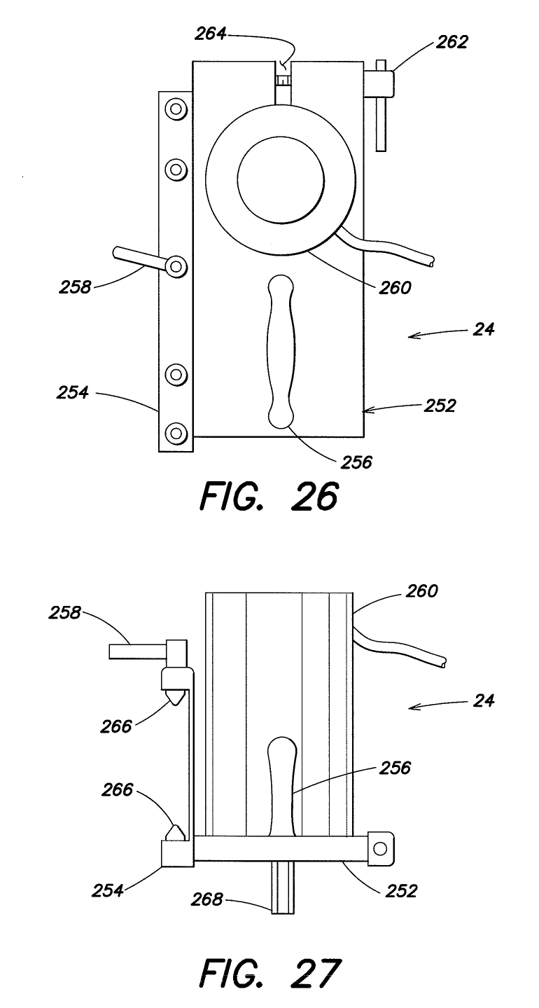

Now referring to FIGS. 26 and 27, in an alternative embodiment the cutter head assembly 24 includes a frame 252, a track guide 254, a handle 256, a lock screw 258, a powered cutting tool 260, and a tool clamp 262. The frame 252 and the track guide 254 are attached to one another. The frame 252 includes a mounting port 264 for the powered cutting tool 260, and the tool clamp 262 cooperates with the mounting port 264 to attach the cutting tool 260 to the frame 252; e.g., rotating the threaded rod 262 clamps the tool 260 by draw two sections of the frame 252 together. Alternative means for fixing the cutting tool 260 to the frame 252 may be used. The handle 256 is shown attached to the frame 252. The track guide 254 is a C-shaped member that is attached to one side of the frame 252. A pair of opposing guide elements 266 is attached to the interior of the track guide 254. The guide elements 266 are shaped and spaced apart from one another to form a mating pair with the opposing guide flanges 66 extending outwardly from the cutter head track 26. The guide elements 266 form a slide fit with the opposing guide flanges 66 to permit the cutter head assembly 24 to be moved linearly along the cutter head track 26. A rotary type powered cutting tool 260 is shown with a rotary acting milling-type tool bit 268. The cutting tool 260 may be powered, for example, electrically or pneumatically. The geometry of the tool bit 260 can be selected to provide particular edge characteristics. The cutting tool 260 also allows the depth of cut to be adjusted for different applications. The cut provided may be all the way through the workpiece, or less than all the way through. The present invention is not limited to a rotary cutter 260 utilizing a milling-type tool bit. The lock screw 258 is operable to fix the cutter head assembly 24 at positions along the cutter head track 26.

In the operation of the device embodiment shown in FIGS. 26 and 27, the cutter head assembly 24 may be positioned at point on the cutter head track 26 above the workpiece and the depth of the tool bit 268 appropriately adjusted. The workpiece may be inserted, aligned, and clamped as described above. Once the workpiece is secure, the powered rotary cutter 260 may be turned on, and be manually brought into contact with the workpiece and the cut completed. In alternative embodiments, the cutter head assembly 24 may be driven along the cutter head track 26 using one of the drive units 209 described above.

Although this invention has been shown and described with respect to the detailed embodiments thereof, it will be understood by those skilled in the art that various changes in form and detail thereof may be made without departing from the spirit and the scope of the invention.

What is claimed is:

1. An apparatus for cutting a workpiece sheet, comprising:
a frame member;
a clamp assembly having a bar that is selectively operable between a retracted position and a deployed position, which clamp assembly is operable to fix the position of the workpiece sheet relative to the frame member;
a cutter head assembly mounted on a track, which track is attached to the frame member, wherein the cutter head assembly can be selectively moved along the track; and
a cartridge removably mounted in the cutter head assembly, wherein the cartridge includes a first cutting blade and a second cutting blade, both blades statically mounted on the cartridge, wherein each blade is positioned to engage the workpiece sheet as the cartridge is moved along the frame member.

2. The apparatus of claim 1, wherein the first cutting blade is positioned to make a first depth of cut into the workpiece sheet and the second cutting blade is positioned to make a second depth of cut into the workpiece sheet, and the second depth of cut is greater than the first depth of cut.

3. The apparatus of claim 2, wherein each of the first cutting blade and the second cutting blade has a cutting edge, and the cutting edges are aligned with one another.

4. The apparatus of claim 3, wherein the first cutting blade and the second cutting blade are coplanar with one another.

5. The apparatus of claim 4, wherein the first cutting blade and the second cutting blades are geometrically the same.

6. The apparatus of claim 4, wherein the first cutting blade and the second cutting blade are made from the same type of material.

7. The apparatus of claim 2, wherein the first cutting blade and the second cutting blade are made from dissimilar materials.

8. The apparatus of claim 2, wherein the first cutting blade is designed to cut a first material, and the second cutting blade is designed to a second material, wherein the first material is different than the second material.

9. The apparatus of claim 1, wherein the cartridge further comprises a pivotable guard that is biased in a deployed position where it at least partially encloses the first and second cutting blades.

10. The apparatus of claim 9, wherein the cartridge includes a selectively operable lock mechanism operative to lock the guard in the deployed position.

11. The apparatus of claim 10, wherein the lock mechanism is configured to be in an unlocked position when the cartridge is mounted within the cutter head assembly, and is configured to normally be in a locked position when the cartridge is separate from the cutter head assembly.

12. A cutter cartridge, comprising:
a frame;
a first cutting blade statically mounted to the frame;
a second cutting blade statically mounted to the frame; cartridge, wherein the first cutting blade has a first blade exposure distance, and the second cutting blade has a second blade exposure distance, and the second blade exposure distance is greater than the first blade exposure distance.

13. The cartridge of claim 12, wherein each of the first cutting blade and the second cutting blade has a cutting edge, and the cutting edges are aligned with one another.

14. The cartridge of claim 13, wherein the first cutting blade and the second cutting blade are coplanar with one another.

15. The cartridge of claim 14, wherein the first cutting blade and the second cutting blades are geometrically the same.

16. The cartridge of claim 14, wherein the first cutting blade and the second cutting blade are made from the same type of material.

17. An apparatus for cutting a workpiece sheet, comprising:
a frame member;
a clamp assembly having a bar that is selectively operable between a retracted position and a deployed position, which clamp assembly is operable to fix the position of the workpiece sheet relative to the frame member;
a cutter head assembly mounted on a track, which track is attached to the frame member, wherein the cutter head assembly can be selectively moved along the track; and
a powered cutting tool having a rotary tool bit operable to cut the workpiece sheet, wherein the powered cutting tool is attached to the cutter head assembly.
